(19) United States
(12) Patent Application Publication
(10) Pub. No.: US 2026/0109628 A1
(43) Pub. Date: Apr. 23, 2026

(54) FLOW TESTING AND DECHLORINATION DEVICE AND METHOD

(71) Applicant: David S. MATTHEWS, Putnam, CT (US)

(72) Inventor: David S. MATTHEWS, Putnam, CT (US)

(21) Appl. No.: 19/121,640

(22) PCT Filed: Nov. 27, 2023
(86) PCT No.: PCT/US2023/081091

§ 371 Date: Apr. 16, 2025

Related U.S. Application Data
(60) Provisional application No. 63/385,300, filed on Nov. 29, 2022.

(51) Int. Cl. C02F 1/68; C02F 101/12

(52) U.S. Cl. CPC C02F 1/686; C02F 1/688; C02F 2101/12; C02F 2209/40; C02F 2209/42; C02F 2301/063; C02F 2303/185

(57) ABSTRACT

The invention relates generally to water testing devices and, more particularly, to devices and methods for water flow testing and dechlorination. In some embodiments, the invention provides a device with interchangeable tablet- and liquid-based dechlorination chambers.

### CROSS-REFERENCE TO RELATED APPLICATIONS

This application claims the benefit of co-pending U.S. Provisional Patent Application Ser. No. 63/385,300, filed 29 Nov. 2022, which is hereby incorporated herein as though fully set forth.

### BACKGROUND

Various devices are known for testing and flushing fire hydrants. In order to avoid discharging chlorinated water onto vegetation or into natural bodies of water, it is desirable to remove some or all of the chlorine from water as it is discharged from a fire hydrant during testing or flushing. To do so, separate dechlorinating devices may be employed upstream or downstream from any testing or flushing device that may be connected to the fire hydrant.

Depending on the concentration of chlorine in water discharged from a fire hydrant, the sensitivity of the vegetation or body of water onto or into which such discharged water will flow, or both, dechlorination may require the use of tablet dechlorinating agents or liquid dechlorinating agents. Typical tablet dechlorinating agents are capable of removing up to about 10 parts per million (ppm) chlorine from discharged water. Liquid dechlorinating agents are able to remove up to about 100 ppm chlorine from discharged water.

Thus, in addition to any testing or flushing devices needed, proper dechlorination of discharged water may require a fire department or other agency tasked with such testing or flushing to also have on had at least two kinds of dechlorinating devices-one for use with tablet dechlorinating agents and another for use with liquid dechlorinating agents.

### SUMMARY

One aspect of the invention provides a dechlorination device comprising: a body having an input, an output, and a first attachment port between the input and the output; and at least one dechlorination chamber adapted to be alternately attached to and detached from the first attachment port, the at least one dechlorination chamber being selected from a group consisting of: a tablet dechlorination chamber comprising a first end, a second end, and a body therebetween adapted to contain one or more dechlorination tablets, the first end including a plurality of perforations into an interior of the body; and a liquid dechlorination chamber comprising: a body having a sealed first end and a sealable second end, such that a quantity of liquid dechlorinating agent may be contained therebetween; and a vacuum port extending through a wall of the body between the sealed first end and the sealable second end.

Another aspect of the invention provides a dechlorination device comprising: a body: an input having a first diameter; an output having a second diameter greater than the first diameter; and an attachment port between the input and the output; and a tablet dechlorination chamber adapted to be alternately attached to and detached from the attachment port comprising: a first end; a cap adapted to alternately seal and open the first end; a second end; and a body between the first end and the second end adapted to contain one or more dechlorination tablets, the first end including a plurality of perforations into an interior of the body.

Still another aspect of the invention provides a dechlorination device comprising: a body: an input having a first diameter; an output having a second diameter greater than the first diameter; a first attachment port between the input and the output; and a second attachment port between the input and the output; a liquid dechlorination chamber comprising: a body having a sealed first end and a sealable second end, such that a quantity of liquid dechlorinating agent may be contained therebetween; a vacuum port extending through a wall of the body above the sealed first end; and a tubular member extending from the vacuum port to the second attachment port of the dechlorination device body between the input and the first attachment port.

Other aspects of the invention provide methods of dechlorinating water using a dechlorination device according to embodiments of the invention. In some aspects, the dechlorination device used in such methods includes a tablet dechlorination chamber. In other aspects, the dechlorination device used in such methods includes a liquid dechlorination chamber.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a perspective view of a dechlorination device according to one embodiment of the invention in which a tablet dechlorination chamber is shown detached from a first attachment port of the dechlorination device.

FIG. 2 shows a perspective view of the dechlorination device of FIG. 1 in which the tablet dechlorination device is affixed to the first attachment port.

FIG. 3 shows a perspective view of a dechlorination device according to another embodiment of the invention in which a liquid dechlorination chamber is shown affixed to the first attachment port and a tubular member extends between a vacuum port of the liquid dechlorination chamber and a second attachment port.

FIG. 4 shows a perspective view of components of a dichlorination device according to another embodiment of the invention in which a tablet dechlorination chamber and optional device are shown detached from a first attachment port and output, respectively, of the dechlorination device.

It is noted that the drawings of the invention are not to scale. The drawings are intended to depict only typical aspects of the invention, and therefore should not be considered as limiting the scope of the invention.

### DETAILED DESCRIPTION

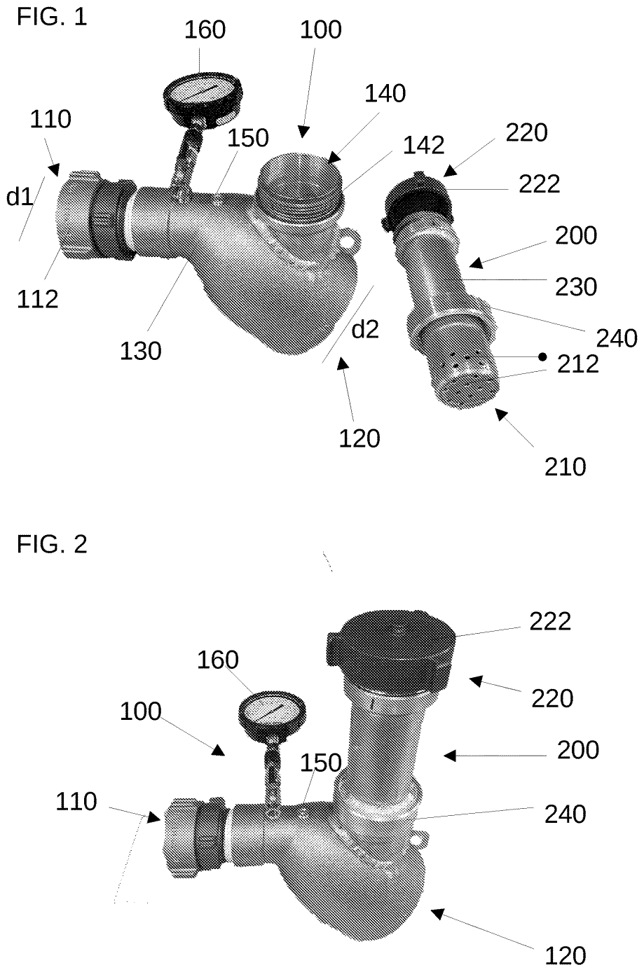

Turning now to the drawings, FIG. 1 shows a dechlorination device 100 comprising a body 130 having an input 110, an output 120, and a first attachment port 140 between the input 110 and the output 120. A tablet dechlorination chamber 200 is shown detached from the dechlorination device 110 and will be described in greater detail below.

The input 110 of the dechlorination device 100 includes a threaded member 112. As shown in FIG. 1, the threaded member 112 comprises a female national pipe thread (NPT) fitting which may be used to connect the dechlorination device 100 directly to a fire hydrant or other system to be tested or flushed or to any number of adapters that may be employed in doing so, as will be recognized by one skilled in the art. As one so skilled will also recognize, while the threaded member 112 may represent the most commonly employed means for connecting devices such as the dechlorination device 100 to fire hydrants and other systems, this is neither necessary nor essential. Any number of devices or techniques may be employed to connect the dechlorination device 100 to a fire hydrant or other system as needed. Those devices and techniques shown in the drawings and described herein should be viewed as illustrative and not limiting of the invention in any regard.

The input 110 has a first diameter d1 and the output 120 has a second diameter d2. In some embodiments of the invention, to facilitate rather than restrict flow through the dechlorination device 100, the second diameter d2 is greater than the first diameter d1. As can be seen in FIG. 1, input 110 and output 120 are angled with respect to each other, with output 120 being oriented in a somewhat downward direction when input 110 is oriented approximately horizontally, as would be expected when connected to a fire hydrant or similar device. As will be explained in greater detail below with respect an alternative embodiment of the invention, this is neither necessary nor essential. Input 110 and output 120 may alternatively be substantially inline with each other or may be disposed at an angle greater or less than that shown in FIG. 1. In some cases, additional attachment devices may be affixed to output 120 that themselves impart an angle to water discharged from the output 120.

Between the input 110 and the output 120 is a first attachment port 140 to which a dechlorination chamber may alternately be attached and detached. As shown in FIG. 1, the first attachment port 140 is provided with a threaded member 142. Specifically, the threaded member 142 is a male thread, such as a male national hose (NH) thread, although other thread types and other attachment means are feasible and within the scope of the invention.

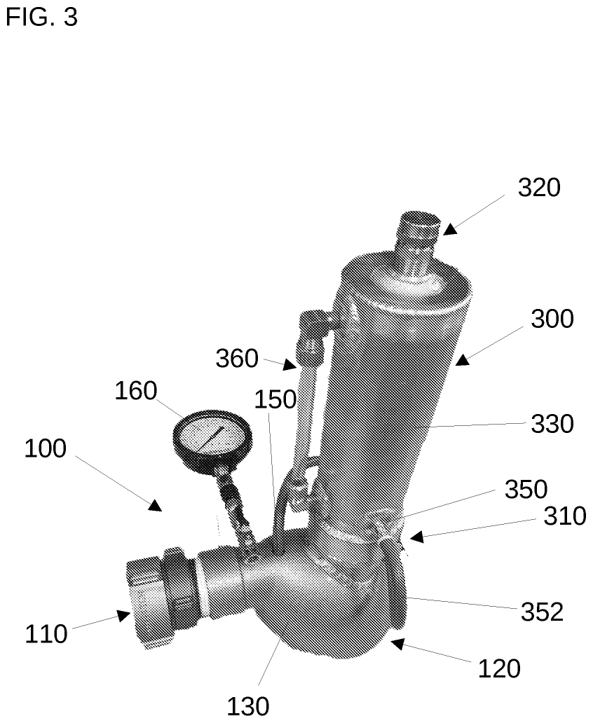

In some embodiments, the dechlorination device 100 may include one or more additional attachment ports. In FIG. 1, for example, a second attachment port 150 is shown between the input 110 and the first attachment port 140. Its function will be described in greater detail below with respect to the embodiment shown in FIG. 3.

The dechlorination device 100 may further include other features useful in flushing or testing fire hydrants and similar systems. For example, according to some embodiments, the dechlorination device 100 includes a flow measuring device 160 capable of measuring various aspects of the water passing through the dechlorination device 100. As shown in FIG. 1, flow measuring device 160 comprises a pitot assembly capable of measuring the velocity of water passing through the dechlorination device 100. The flow measuring device 160 may similarly be used to measure water pressure, water volume, or any other characteristic.

A tablet dechlorination chamber 200 is operable to be alternately attached to and detached from the first attachment port 140. The tablet dechlorination chamber 200 includes a body 230 with a first end 210 and a second end 220. The second end 220 may be alternately opened and closed using a cap 222 or similar device to provide access to an interior of the tablet dechlorination device 200. As will be understood by one skilled in the art, upon opening the second end 220 by removing the cap 222, one or more dechlorination agent tablets (not shown) may be deposited inside the tablet dechlorination chamber 200 and the second end 220 closed by replacing the cap 222.

The first end 210 includes a plurality of perforations 212 extending into an interior of the tablet dechlorination chamber 200. When the tablet dechlorination chamber 200 is affixed to the first attachment port 140, as is further described below, water (not shown) passing through the dechlorination device 100 enters the plurality of perforations 212 and into an interior of the tablet dechlorination chamber 200, thereby bringing the water into contact with dechlorination agent tablets (not shown) therein, whereby the water is chemically dechlorinated before being discharged through the output 120.

The tablet dechlorination chamber 200 includes an attachment device 240 for securing the tablet dechlorination chamber 200 to the first attachment port 140. As shown in FIG. 1, the attachment device 240 comprises a female threaded fitting corresponding to the threaded member 142 of the first attachment port 140. As can be seen, upon securing the attachment device 240 to the first attachment port 140, the first end 210 of the tablet dechlorination chamber 200 sits within the body 130 of the dechlorination device 100 between the input 110 and the output 120. So positioned, water passing through the dechlorination device 100 may be chemically dechlorinated as described above. FIG. 2 shows the tablet dechlorination chamber 200 affixed to the first attachment port 140.

As noted above, in some instances, tablet dechlorinating agents may be inadequate to dechlorinate water being passed through the dechlorination device 100. In such instances, it may be beneficial to employ one or more liquid dechlorinating agents, which are typically capable of removing more chlorine from water than are tableted or powdered dechlorinating agents.

FIG. 3 shows the dechlorination device 100 according to another embodiment of the invention, where the tablet dechlorination chamber 200 in FIGS. 1 and 2 is replaced with a liquid dechlorination chamber 300.

Like the tablet dechlorination chamber 200 (FIGS. 1 and 2), the liquid dechlorination chamber 300 has a body 330, a first end 310, a second end 320, and an attachment device for securing it to the first attachment port 340, but differs from the tablet dechlorination chamber 200 in important respects. For example, its first end 310 is sealed. That is, there is no access to an interior of the liquid dechlorination chamber 300 via the first end 310. Rather, liquid dechlorinating agent (not shown) is deposited into an interior of the liquid dechlorination chamber 300 from the second end 320, which is adapted to be alternately sealed and unsealed to facilitate such deposition. The level of liquid dechlorinating agent within the liquid dechlorination chamber 300 may be determined using a gauge 360 or similar device. In FIG. 3, the gauge 360 comprises a sight tube. Other devices may be similarly employed, as will be recognized by one skilled in the art.

The liquid dechlorinating agent contained within the liquid dechlorination chamber 300 is mixed with water passing through the dechlorination device 100 by way of a tubular member 352 extending from a vacuum port 350 to the second attachment port 150. The vacuum port 350 extends through a wall of the body 330 of the liquid dechlorination chamber 300. In response to decreased pressure at the second attachment port 150 caused by water passing through the dechlorination device 100, the liquid dechlorinating agent is pulled from inside the liquid dechlorination chamber 330, through the vacuum port 350 and tubular member 352, into the second attachment port 150, where it is combined with the water passing through the dechlorination device 100.

The second attachment port 150 may be plugged, capped, or otherwise sealed when not in use, such as, for example, when the tablet dechlorination chamber 200, rather than the liquid dechlorination chamber 300, is in use.

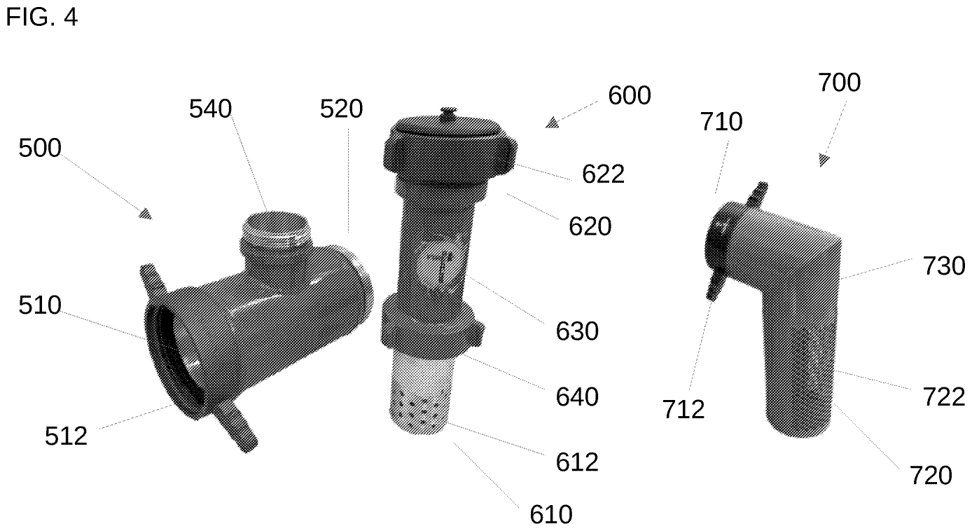

FIG. 4 shows a perspective view of components of a dechlorination device 500 and tablet dechlorination chamber 600 according to an alternative embodiment of the invention, along with an optional steamer attachment 700. As in the embodiment shown in FIG. 1, the dechlorination device 500 includes an input 510 and an output 520. Here, however, the input 510 and output 520 are substantially inline with respect to each other rather than angled. The dechlorination device 500 further includes a threaded member 512, body 530, and first attachment port 540, the functions of which are similar to those described above with respect to the embodiment in FIG. 1. Although not shown in FIG. 4, the dechlorination device 500 may further include a second attachment port, flow measuring device, or other components in a manner similar to the embodiment described with respect to FIG. 1.

The tablet dechlorination chamber 600 is similar to the embodiment shown in FIG. 1, with a first end 610 having a plurality of perforations 612, a second end 620 with a cap 622 or similar device, a body 630 between the first end 610 and the second end 620, and an attachment device 640 for affixing the tablet dechlorination chamber 600 to the first attachment port 540 of the dechlorination device 500.

FIG. 4 also shows an optional device for attachment to the second end 520 of the dechlorination device 500. Specifically, the optional device is shown as what is commonly known as a steamer attachment 700. An input 710 of the steamer attachment 700 is affixed to the output 520 of the dechlorination device 500 using a compatible threaded member 712 or similar device. Once so affixed, dechlorinated water passing through the dechlorination device 500 through the output 520 will pass into the steamer attachment 700 through the input 710, through a body 730, and then out through an output 720. In FIG. 4, the output 720 of the steamer attachment is shown as a plurality of perforations 722, though this is neither necessary nor essential. However, the perforations 722 aid in diffusing dechlorinated water discharged through the steamer device 700 over a larger area, thereby minimizing or avoiding erosion or damage to surfaces onto which the dechlorinated water is discharged.

As in the embodiment described above in FIGS. 1 and 2, the dechlorination device 500 may be affixed to a liquid dechlorination chamber (not shown), which would function in a similar manner.

Although the dechlorination device 100 above is described as including a first attachment port and a second attachment port, one skilled in the art will recognize that any number of additional attachment ports in any form or forms may be included to facilitate the connection of metering devices, fittings, venturi/vacuum fittings, sight glasses, and the like.

Similarly, the dechlorination device 100, tablet dechlorination chamber 200, and liquid dechlorination chamber 300 may be composed of any number of materials. Aluminum and aluminum alloys are among the more preferred materials, due to their relatively light weight, but other materials may also be employed, such as brass, copper, etc. Other suitable materials would be apparent to one skilled in the art and are within the scope of the invention.

Tubular member 352 may also be composed of any number of materials. In some embodiments, the tubular member 352 is flexible to facilitate connecting it between the vacuum port 350 and the second attachment port 150. In such embodiments, tubular member 352 may be composed of natural or synthetic rubbers, polyethylene, polypropylene, or similar materials. In other embodiments, where, for example, the tubular member may be connected between the vacuum port 350 and the second attachment port 150 for an extended period, the tubular member 352 may be of a more rigid material, such as aluminum, copper, brass, polyvinylchloride (PVC), or similar materials. Other suitable materials would be apparent to one skilled in the art and are within the scope of the invention.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A dechlorination device comprising:
a body having an input, an output, and a first attachment port between the input and the output; and
at least one dechlorination chamber adapted to be alternately attached to and detached from the first attachment port, the at least one dechlorination chamber being selected from a group consisting of:
a tablet dechlorination chamber comprising a first end, a second end, and a body therebetween adapted to contain one or more dechlorination tablets, the first end including a plurality of perforations into an interior of the body; and
a liquid dechlorination chamber comprising:
a body having a sealed first end and a sealable second end, such that a quantity of liquid dechlorinating agent may be contained therebetween; and
a vacuum port extending through a wall of the body between the sealed first end and the sealable second end,
wherein the tablet dechlorination chamber and the liquid dechlorination chamber are alternately attachable to the first attachment port.

2. The dechlorination device of claim 1, wherein the output has a diameter greater than a diameter of the input.

3. The dechlorination device of claim 1, wherein the input and the first attachment port include threaded members.

4. The dechlorination device of claim 1, wherein the tablet dechlorination chamber further includes an attachment device between the first end and the second end for attachment to the first attachment port, such that, when attached to the first attachment port, the first end of the tablet dechlorination chamber sits within the body of the dechlorination device between the input and the output.

5. The dechlorination device of claim 1, wherein the first end of the tablet dechlorination chamber includes a cap adapted to alternately seal and open the first end.

6. The dechlorination device of claim 1, further comprising:
a second attachment port between the input and the first attachment port.

7. The dechlorination device of claim 6, wherein the liquid dechlorination chamber further comprises:
a tubular member extending from the vacuum port to the second attachment port of the dechlorination device body.

8. The dechlorination device of claim 7, wherein liquid dechlorinating agent is pulled from the liquid dechlorinating chamber through the vacuum port, through the tubular member, and into the second attachment port of the dechlorination device under vacuum pressure as water flows through the dechlorination device from the input to the output.

9. The dechlorination device of claim 1, wherein the liquid dechlorination chamber further comprises:
a gauge readable from an exterior of the liquid dechlorination chamber measuring a level of liquid dechlorinating agent within the liquid dechlorination chamber.

10. (canceled)

11. The dechlorination device of claim 1, further comprising:
a flow measuring device between the input and the output for measuring water flow through the body.

12. The dechlorination device of claim 11, wherein the flow measuring device includes a pitot assembly.

13. A dechlorination device comprising:
a body;
an input having a first diameter;
an output having a second diameter greater than the first diameter;
an attachment port between the input and the output; and
a tablet dechlorination chamber adapted to be alternately attached to and detached from the attachment port comprising:
a first end;
a cap adapted to alternately seal and open the first end;
a second end; and
a body between the first end and the second end adapted to contain one or more dechlorination tablets, the first end including a plurality of perforations into an interior of the body,
wherein the tablet dechlorination chamber further includes an attachment device between the first end and the second end for attachment to the attachment port, such that, when attached to the attachment port, the first end of the tablet dechlorination chamber sits within the body of the dechlorination device between the input and the output.

14. (canceled)

15. A dechlorination device comprising:
a body;
an input having a first diameter;
an output having a second diameter greater than the first diameter;
a first attachment port between the input and the output;
a second attachment port between the input and the output; and
a liquid dechlorination chamber comprising:
a body having a sealed first end and a sealable second end, such that a quantity of liquid dechlorinating agent may be contained therebetween;
a vacuum port extending through a wall of the body above the sealed first end; and
a tubular member extending from the vacuum port to the second attachment port of the dechlorination device body between the input and the first attachment port.

16. The dechlorination device of claim 15, wherein liquid dechlorinating agent is pulled from the liquid dechlorinating chamber through the vacuum port, through the tubular member, and into the second attachment port of the dechlorination device under vacuum pressure as water flows through the dechlorination device from the input to the output.

17. The dechlorination device of claim 15, wherein the liquid dechlorination chamber further comprises:
a gauge readable from an exterior of the liquid dechlorination chamber measuring a level of liquid dechlorinating agent within the liquid dechlorination chamber.

18. A method of dechlorinating water, the method comprising:
affixing the dechlorination device of claim 1 to a fire hydrant; and
passing a quantity of water through the dechlorination device.

19. The method of claim 18, wherein the dechlorination device includes the tablet dechlorination chamber containing one or more dechlorinating agent tablets.

20. The method of claim 18, wherein the dechlorination device includes the liquid dechlorinating chamber containing a quantity of liquid dechlorinating agent.
